(19) United States
(12) Patent Application Publication
(10) Pub. No.: US 2002/0113337 A1
(43) Pub. Date: Aug. 22, 2002

(54) Process for the production of filler-containing molded parts and apparatus useful therefor

(76) Inventors: Reiner Napp, Bonn (DE); Ferdinand Althausen, Neunkirchen (DE); Wolfgang Pawlik, Koln (DE)

Correspondence Address: BAYER CORPORATION, PATENT DEPARTMENT, 100 BAYER ROAD, PITTSBURGH, PA, 15205, US

(21) Appl. No.: 10/014,084

(22) Filed: Dec. 11, 2001

(30) Foreign Application Priority Data
Dec. 14, 2000 (DE) 10062420.0

(51) Int. Cl. B29C 45/00; B29B 15/08

(52) U.S. Cl. 264/240; 264/328.6; 264/328.18; 264/334; 425/130

(57) ABSTRACT

Filler-containing molded parts or articles are produced from a free-flowing reaction mixture, e.g. of polyol and isocyanate, in a manner which permits the changeover to a different filler content to be carried out more rapidly and, possibly, without material loss. This is achieved by dividing at least one of the reaction components into at least two portions, at least one of which is charged with filler, by adjusting the mixing ratio of these portions and hence the filler content of the finished molded part. At least two storage vessels are provided for at least one of the reaction components. Adjustable metering devices are arranged between these two storage vessels and the mixing device.

### BACKGROUND OF THE INVENTION

The present invention relates to a process and to an apparatus for the production of filler-containing molded parts or articles from a free-flowing reaction mixture. In the process of the present invention, at least two free-flowing chemical reaction components of which at least one contains filler are caused to react by mixing. The free-flowing reaction mixture is introduced into a mold where it finishes reacting. The molded article or part is then removed from the mold.

It is generally known to manufacture filler-containing molded polyurethane parts by mixing and reacting a polyol and an isocyanate, at least one of which contains filler and introducing the resulting reaction mixture into a mold, allowing it to cure and subsequently removing it from the mold.

Examples of chemical reaction components used in such processes include isocyanates and polyols. Preferred fillers include fibers such as glass fibers, carbon fibers and natural fibers, e.g., jute and hemp fibers. Substances in the form of granules and powders such as recycled products, melamine and chalk may also be used, however.

Currently, such molded parts are usually manufactured in relatively large plants. Lines from storage vessels with agitators lead via metering devices to mixing devices which are assigned to one mold in each case, e.g., in a so-called multi-point metering system. One or two of such molds may be arranged on one stationary mold support.

It is often necessary to manufacture, in the same plant, molded parts or articles of identical or different shape but which have a different filler content. To this end, a batch of one reaction component and filler in the corresponding amount is prepared in a storage vessel.

Changing over from one series of molded parts to another one with a different filler content then requires the preparation of a new batch of reaction component(s) and cleaning of the plant to remove the previous filler-containing reaction component. This means lost production time due to the time required for the changeover, as well as a loss of material.

### SUMMARY OF THE INVENTION

The object of the present invention is to provide the ability to changeover to a reaction mixture with a different filler content during the production of filler-containing molded parts more rapidly and, if possible, without loss of material.

This and other objects which will be readily apparent to those skilled in the art are achieved by dividing at least one of the reaction components into at least two parts and charging at least one of those parts with filler. Adjusting the mixing ratio of the reaction component parts also adjusts the filler content of the finished molded part.

### BRIEF DESCRIPTION OF THE DRAWINGS

FIG. 1 illustrates an apparatus suitable for carrying out the process of the present invention in which only one of the chemical reaction components is divided into two portions—one portion containing filler and the other containing no filler.

FIG. 2 illustrates an apparatus suitable for carrying out the process of the present invention in which both chemical reaction components are divided into two portions with one portion of each. component containing filler and the other portion containing no filler.

FIG. 3 is a schematic representation of the streams flowing into a mixing device in the apparatus illustrated in FIG. 2.

### DETAILED DESCRIPTION OF THE INVENTION

In the process of the present invention, at least one of the reaction components is divided into two portions. One of those portions includes a filler. The other portion does not. Adjustment of the mixing ratio of these portions makes it possible to change the filler content of the finished molded part without significant disruption to the production process.

As a result, a changeover to a reaction mixture having a different filler content can take place more or less by means of a simple switchover, while retaining the polyol-polyisocyanate formulation ratio, by altering the proportion of the filler-free portion fed to the filler-containing portion, or, alternatively, the proportion of the first filler-containing portion fed to the second filler-containing portion.

The chemical formulation, i.e. the quantity ratio of the reaction components to one another, remains constant during a change in filler content in the process of the process of the present invention. If only one filler-containing component part is made available, this should correspond at least to the maximum expected filler content in the finished molded part in order that all the filler contents may be adjusted to the possible maximum content. If component parts are charged with filler, the charge with filler must be different. One part should have a high filler content and the other a low filler content in order that the desired filler content may be adjusted in the molded part.

In one embodiment of the process of the present invention, at least two portions of the same type of reaction component charged with filler in different amounts are made available for processing or processed.

It is also possible to make available for processing or to process one filler-free portion and one filler-containing portion of each of the two reaction components.

It goes without saying that at least one of the reaction components may also be divided into more than two portions, at least two portions being charged with filler. This is not necessary as a rule, however, and far too much equipment is required.

Fibers are preferably used as fillers. Examples of suitable fiber materials include: mineral fibers such as glass fibers; synthetic fibers such as polyamide fibers; and natural fibers such as jute or hemp fibers.

Suitable fillers also include the conventional fillers in the form of granules such as recycled products or in the form of powders such as melamine or chalk.

The apparatus for the production of filler-containing molded parts from a free-flowing reaction mixture in accordance with the present invention is based on at least two storage vessels for free-flowing chemical reaction components, at least one of which is charged with filler. The storage vessels are generally connected by metering devices to at least one mixing device which opens into a mold.

At least two storage vessels are provided for at least one of the reaction components. At least one of the two portions of this reaction component is charged with filler. Adjustable metering devices are arranged between these two storage vessels and the mixing device.

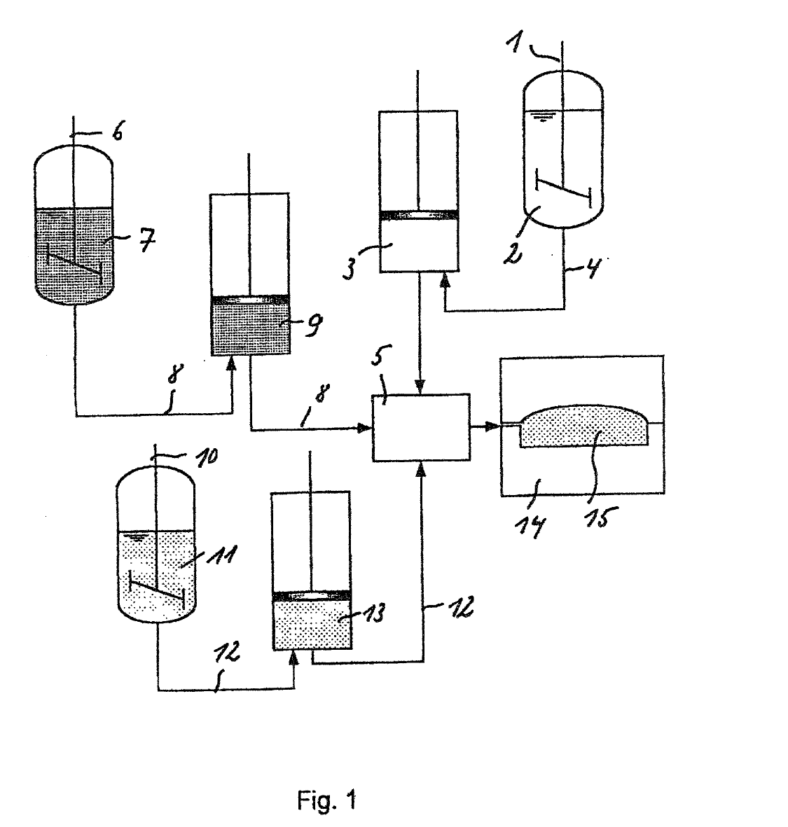

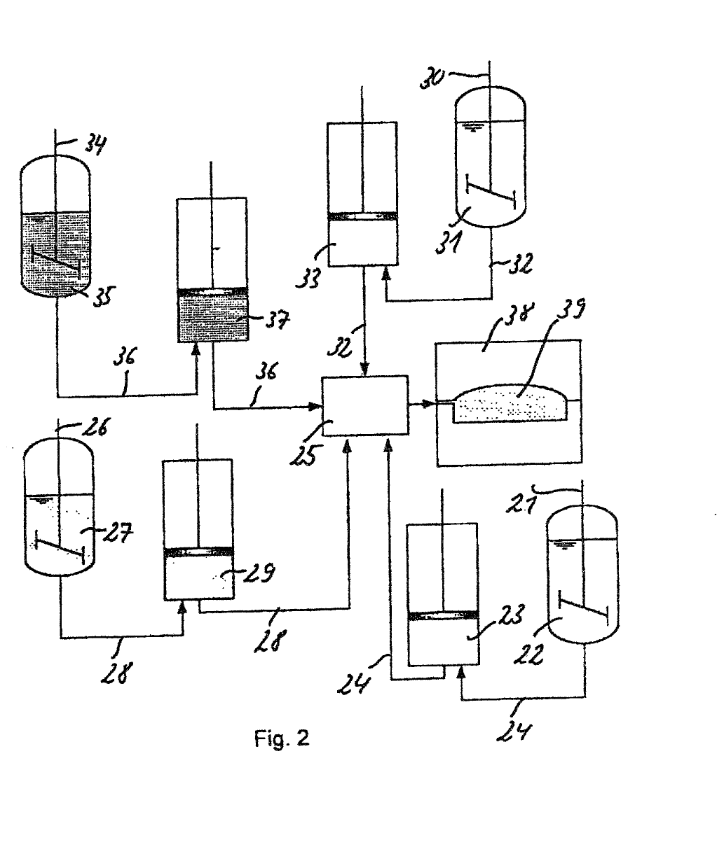

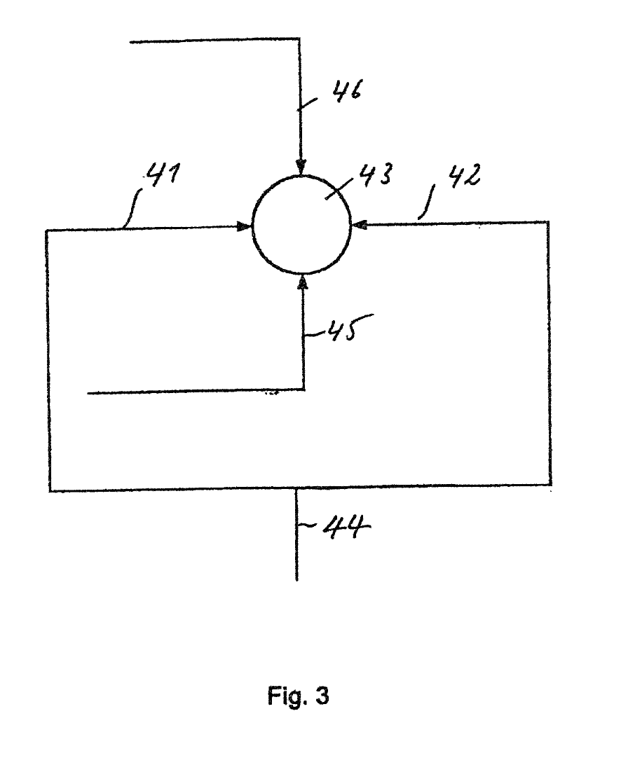

FIGS. 1 and 2 show purely schematic views of apparatus suitable for the production of filler-containing molded parts of polyurethane from isocyanate and polyol reaction components in accordance with the present invention. FIG. 1 shows a first embodiment of a suitable device, FIG. 2 shows a second embodiment of the device, and FIG. 3 shows a top view onto the mixing device and onto the lines leading into it for the reaction components optionally charged with filler.

In FIG. 1, line 4 leads from storage vessel 2 provided with an agitator 1 for filler-free-isocyanate to piston-type metering device 3 and ends in mixing device 5. Line 8 leads from storage vessel 7 provided with an agitator 6 for polyol charged with a high filler content via a piston-type metering device 9 to mixing device 5. Line 12 leads from storage vessel 11 provided with an agitator 10 for polyol charged with a lower filler content via a piston-type metering device 13 into mixing device 5. The mixing device 5 ends in a mold 14 in which a molded part 15 is indicated. Without any substantial alteration to the device described, the storage vessel 11 may alternatively be filled with pure polyol, and the polyol contained in storage vessel 7 is charged at least with the highest expected filler content for the molded part 15 to be produced.

In FIG. 2, line 24 leads from storage vessel 22 provided with an agitator 21 for filler-free isocyanate via a piston-type metering device 23 and ends in mixing device 25. Line 28 leads from storage vessel 27 provided with an agitator 26 for isocyanate charged with a low filler content via piston-type metering device 29 into mixing device 25. Line 32 leads from storage vessel 31 provided with an agitator 30 for filler-free polyol leads via piston-type metering device 33 to mixing device 25. Finally, Line 36 leads from storage vessel 35 provided with an agitator 34 for polyol charged with a high filler content via piston-type metering device 37 into mixing device 25. The mixing device 25 ends in a mold 38 in which a molded part 39 is indicated. In this embodiment too, the storage vessels 22, 27, 31 and 34 can be filled in different ways, depending on the process to be carried out, without any substantial alteration to the structure of the device.

In FIG. 3, two feed lines 41, 42 for filler-containing parts of a reaction component composed of polyol lead into mixing device 43. These feed lines 41, 42 are fed from the branching line 44 and end exactly, diametrically opposite in mixing device 43. At 90° to these, a feed line 45 for filler-free polyol and a feed line 46 for filler-free isocyanate end opposite one another. It goes without saying that mixing device 43 may be fed in a different way via feed lines 41, 42, 45, 46, according to the mode of operation selected. In order to illustrate only one variant, for example, only two filler-containing parts of the same reaction component can be introduced opposite one another via feed lines 41 and 42, while the two other feed lines 45 and 46 are being fed with the other, filler-free reaction component. In order to obtain particularly good mixing, it is advantageous if the energy of the flows in opposite feed lines are of the same order of magnitude.

During the manufacture of molded parts, the isocyanate-polyol-filler mixture produced at any one time in the mixing device must comply with the required ratios. That is, not only must the quantity ratios of the individual components in the mold be absolutely correct but also the ratios of the individual volumetric flows to one another must likewise be complied with at any one time.

The following modes of operation may be carried out with the apparatus of the present invention.

### EXAMPLES

### Example 1

The apparatus illustrated in FIG. 1 was used to manufacture a polyurethane molded part containing glass in the form of fibers as filler. The reaction components were isocyanate and polyol and glass. The total volume was 3,000 cm³. The glass content in the finished molded part was 14 wt. %. The two reaction components were fed in a mass ratio of 100:170.9. The polyol component was divided into a filler-free part and a filler-containing part. The mass ratio of polyol to glass in the filler-containing reaction component was 100:80. The densities of the reaction components were 1.02 kg/l for the polyol, 1.12 kg/l for the isocyanate and 2.56 kg/l for the glass. The density of the filler-containing polyol can be calculated from this at 1.392 kg/l. If a metering or filling time of 0.8 sec is selected, the following volumetric flows are obtained:

| | | |
|---|---|---|
| Isocyanate: | 2,136.5 | cm³/sec |
| Filler-containing polyol: | 997.8 | cm³/sec |
| Filler-free polyol: | 615.7 | cm³/sec. |

The production was then changed over to increase the glass fiber content in the molded part to 22 wt. % while maintaining the same molded part volume. Here, too, the reaction components must be fed in a mass ratio of 100:170.9. The mass ratio of polyol to glass in the filler-containing component likewise remained constant at 100:80. With the same metering or filling time of 0.8 sec and a glass content of 22 wt. % in the finished molded part, the following volumetric flows are calculated:

| | | |
|---|---|---|
| Isocyanate: | 2,040.3 | cm³/sec |
| Filler-containing polyol: | 1,651.0 | cm³/sec |
| Filler-free polyol: | 58.7 | cm³/sec. |

### Example 2

The apparatus illustrated in FIG. 1 was used to manufacture a polyurethane molded part containing glass in the form of fibers as filler. The reaction components were isocyanate and polyol and glass. The total volume was 3,000 cm³. The glass content in the finished molded part was 14 wt. %. The two reaction components were fed in a mass ratio of 100:170.9. The polyol component was divided into a filler-poor part, the mass proportions of polyol to glass being 100:40, and into a filler-rich part, the mass proportions of polyol to glass being 100:80. The densities of the pure reaction components were 1.02 kg/l for the polyol, 1.12 kg/l for the isocyanate and 2.56 kg/l for the glass. The resulting densities of the filler-poor polyol and the filler-rich polyol were 1.232 kg/l and 1.392 kg/l respectively. If a metering or filling time of 0.8 sec is selected, the following volumetric flows are calculated:

| | | |
|---|---|---|
| Isocyanate: | 2,136.5 | cm³/sec |
| Filler-rich polyol: | 185.8 | cm³/sec |
| Filler-poor polyol: | 1,427.7 | cm³/sec. |

If the glass proportion of the molded part is to be increased to 22 wt. %, the marginal conditions otherwise remaining the same, the following volumetric flows are calculated.

| | | |
|---|---|---|
| Isocyanate: | 2,040.3 | cm³/sec |
| Filler-rich polyol: | 1,573.6 | cm³/sec |
| Filler-poor polyol: | 136.0 | cm³/sec. |

### Example 3

The apparatus illustrated in FIG. 1 was used to produce a polyurethane molded part containing glass in the form of fibers as filler. The reaction components were isocyanate and polyol and glass. The total volume was 3,000 cm³. The glass content in the finished molded part was 30 wt. %. The two reaction components were fed in a mass ratio of 100:170.9. The polyol component was divided into a filler-free part and a filler-containing part. The mass ratio of polyol to glass in the filler-containing reaction component was 100:80. The isocyanate also contained filler. The mass ratio of isocyanate to glass was 100:60. The densities of the pure reaction components were 1.02 kg/l for the polyol, 1.12 kg/l for the isocyanate and 2.56 kg/l for the glass. The density of the filler-containing polyol can be calculated from this at 1.392 kg/l. The density of the filler-containing isocyanate can be calculated at 1.419 kg/l. If a metering or filling time of 0.8 sec is selected, the following volumetric flows are obtained:

| | | |
|---|---|---|
| Filler-containing isocyanate: | 2,441.0 | cm³/sec |
| Filler-containing polyol: | 277.5 | cm³/sec |
| Filler-free polyol: | 1,031.6 | cm³/sec. |

If the glass proportion of the finished molded part is to be increased to 38 wt. %, the conditions otherwise remaining the same, the following volumetric flows must be set:

| | | |
|---|---|---|
| Filler-containing isocyanate: | 2,290.1 | cm³/sec |
| Filler-containing polyol: | 1,219.6 | cm³/sec |
| Filler-free polyol: | 240.4 | cm³/sec. |

### Example 4

The apparatus illustrated in FIG. 2 was used to produce a polyurethane molded part containing glass in the form of fibers as filler. The reaction components were isocyanate and polyol and glass. The total volume was 3,000 cm³. The glass content in the finished molded part was 30 wt. %. The two reaction components were fed in a mass ratio of 100:170.9. The polyol component was divided into a filler-free part and a filler-containing part. The mass ratio of polyol to glass in the filler-containing reaction component was 100:80. The isocyanate component was likewise divided into a filler-free and a filler-containing part. The mass ratio of isocyanate and glass in the filler-containing part was 100:60. The densities of the pure reaction components were 1.02 kg/l for the polyol, 1.12 kg/l for the isocyanate and 2.56 kg/l for the glass. The density of the filler-containing polyol can be calculated from this at 1.392 kg/l. The density of the filler-containing isocyanate can be calculated at 1.493 kg/l. If a metering or filling time of 0.8 sec is selected, the following volumetric flows are obtained:

| | | |
|---|---|---|
| Filler-containing isocyanate: | 1,958.0 | cm³/sec |
| Filler-free isocyanate: | 483.4 | cm³/sec |
| Filler-containing polyol: | 277.5 | cm³/sec |
| Filler-free polyol: | 1,031.6 | cm³/sec. |

If the glass content of the finished molded part is to be increased to 38 wt. %, the conditions otherwise remaining the same, the following volumetric flows must be set:

| | | |
|---|---|---|
| Filler-containing isocyanate: | 1,837.0 | cm³/sec |
| Filler-free isocyanate: | 453.5 | cm³/sec |
| Filler-containing polyol: | 1,219.6 | cm³/sec |
| Filler-free polyol: | 240.4 | cm³/sec. |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of filler-containing molded parts from a free-flowing reaction mixture comprising:
a) mixing at least two free-flowing chemical reaction components comprising
(1) a first reaction component and
(2) a second reaction component which is divided into at least two portions and at least one of the two portions is charged with filler
in a manner such that the mixing ratio of the portions of the second component may be adjusted to vary the filler content of the molded part,
b) introducing the free-flowing reaction mixture into a mold,
c) allowing the reaction mixture to finish reacting in the mold, and
d) removing the molded part from the mold.

2. The process of claim 1 in which at least two portions of the second reaction component are charged with different amounts of filler.

3. The process of claim 2 in which the first reaction component is divided into one filler-free portion and one filler-containing portion.

4. The process of claim 1 in which each of the first and second reaction components is divided into one filler-free portion and one filler-containing portion.

5. The process of claim 4 in which fibers are used as filler.

6. The process of claim 3 in which fibers are used as filler.

7. The process of claim 2 in which fibers are used as filler.

8. The process of claim 1 in which fibers are used as filler.

9. The process of claim 1 in which glass fibers are used as filler.

10. The process of claim 1 in which a natural fiber is used as filler.

11. The process of claim 1 in which jute or hemp fibers are used as filler.

12. An apparatus for the production of filler-containing molded parts or articles from a free-flowing reaction mixture formed from at least two free-flowing chemical reaction components comprising
a) a first storage vessel for the first free-flowing chemical reaction component,
b) a second storage vessel for a first portion of the second free-flowing chemical reaction component which is charged with filler,
c) a third storage vessel for a second portion of the second free-flowing chemical reaction component,
d) a metering device to control the flow of the first free-flowing chemical reaction component from the first storage vessel,
e) a metering device to control the flow of the first portion of the second free-flowing chemical reaction component from the second storage vessel,
f) a metering device to control the flow of the second portion of the second free-flowing chemical reaction component from the third storage vessel,
g) a mixing device to receive metered amounts of the free-flowing reaction mixture components, and
h) a mold for receiving reaction mixture from the mixing device.
